(19) United States
(12) Patent Application Publication
(10) Pub. No.: US 2025/0056290 A1
(43) Pub. Date: Feb. 13, 2025

(54) MECHANISM FOR USER EQUIPMENT PERFORMANCE FEEDBACK MEASUREMENT REPORTING

(71) Applicant: Nokia Technologies Oy, Espoo (FI)

(72) Inventors: Martin KOLLÁR, Munich (DE); Miltiadis FILIPPOU, Munich (DE); Anna PANTELIDOU, Massy (FR)

(21) Appl. No.: 18/793,190

(22) Filed: Aug. 2, 2024

(30) Foreign Application Priority Data
Aug. 11, 2023 (FI) 20235908

(51) Int. Cl. H04W 24/10; H04L 43/0829; H04W 24/08

(52) U.S. Cl. CPC H04W 24/10; H04L 43/0829; H04W 24/08

(57) ABSTRACT

The present disclosure relates to a solution on reporting UE performance feedback is proposed. In particular, it proposes an online, adaptive, context-aware (and, therefore, relevant to an event experienced by a UE, e.g., UE handover) time configuration framework for UE performance feedback measurement reporting, useful for an NG-RAN node (or “Actor” gNB) to evaluate an ML-based action that has led to this event. In this way, it can provide accurate and proper UE performance feedback, thereby improving performances of the system.

### FIELDS

Various example embodiments of the present disclosure generally relate to the field of telecommunication and in particular, to methods, devices, apparatuses and computer readable storage medium for user equipment (UE) performance feedback measurement reporting.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances. By way of example, the AI/ML may be employed in load balancing and mobility optimization in next generation (NG) radio access network (RAN). Further, based on collection of various measurements and feedbacks from UEs and network nodes, historical data and the like, AI/ML model-based solutions and predicted load could improve load balancing performance, in order to provide higher quality user experience and to improve the system capacity. Therefore, it is worth studying on obtaining accurate and proper feedbacks.

### SUMMARY

In a first aspect of the present disclosure, there is provided a first apparatus. The first apparatus comprises at least one processor; and at least one memory storing instructions that, when executed by the at least one processor, cause the first apparatus to: receive, from a second apparatus, a request for user equipment, UE, performance feedback for a third apparatus, wherein the request indicates a set of measurement requirements; perform a measurement for the UE performance feedback for the third apparatus, and wherein the third apparatus is handed over from the second apparatus to the first apparatus; in accordance with a determination that a termination condition for the measurement is satisfied, determine whether the set of measurement requirements is satisfied based on the measurement for the UE performance feedback; and transmit, to the second apparatus, information related to the UE performance feedback that is based on the determination.

In a second aspect of the present disclosure, there is provided a second apparatus. The second apparatus comprises at least one processor; and at least one memory storing instructions that, when executed by the at least one processor, cause the second apparatus to: transmit, to a first apparatus, a request for user equipment, UE, performance feedback for a third apparatus, wherein the request indicates a set of measurement requirements, and wherein the third apparatus is handed over from the second apparatus to the first apparatus; and receive, from the first apparatus, information related to the UE performance feedback that is based on the determination.

In a third aspect of the present disclosure, there is provided a third apparatus. The third apparatus comprises at least one processor; and at least one memory storing instructions that, when executed by the at least one processor, cause the third apparatus to: perform a handover from a second apparatus to a first apparatus; and transmit, to the first apparatus, at least one positioning signaling that facilitate a measurement for a user equipment, UE, performance feedback for third apparatus.

In a fourth aspect of the present disclosure, there is provided a method. The method comprises: receiving, from a second apparatus, a request for user equipment, UE, performance feedback for a third apparatus, wherein the request indicates a set of measurement requirements; performing a measurement for the UE performance feedback for the third apparatus, and wherein the third apparatus is handed over from the second apparatus to the first apparatus; in accordance with a determination that a termination condition for the measurement is satisfied, determining whether the set of measurement requirements is satisfied based on the measurement for the UE performance feedback; and transmitting, to the second apparatus, information related to the UE performance feedback that is based on the determination.

In a fifth aspect of the present disclosure, there is provided a method. The method comprises: transmitting, to a first apparatus, a request for user equipment, UE, performance feedback for a third apparatus, wherein the request indicates a set of measurement requirements, and wherein the third apparatus is handed over from the second apparatus to the first apparatus; and receiving, from the first apparatus, information related to the UE performance feedback that is based on the determination.

In a sixth aspect of the present disclosure, there is provided a method. The method comprises: performing a handover from a second apparatus to a first apparatus; and transmitting, to the first apparatus, at least one positioning signaling that facilitate a measurement for a user equipment, UE, performance feedback for third apparatus.

In a seventh aspect of the present disclosure, there is provided a first apparatus. The first apparatus comprises means for receiving, from a second apparatus, a request for user equipment, UE, performance feedback for a third apparatus, wherein the request indicates a set of measurement requirements; means for performing a measurement for the UE performance feedback for the third apparatus, and wherein the third apparatus is handed over from the second apparatus to the first apparatus; means for in accordance with a determination that a termination condition for the measurement is satisfied, determining whether the set of measurement requirements is satisfied based on the measurement for the UE performance feedback; and means for transmitting, to the second apparatus, information related to the UE performance feedback that is based on the determination.

In an eighth aspect of the present disclosure, there is provided a second apparatus. The second apparatus comprises means for transmitting, to a first apparatus, a request for user equipment, UE, performance feedback for a third apparatus, wherein the request indicates a set of measurement requirements, and wherein the third apparatus is handed over from the second apparatus to the first apparatus; and means for receiving, from the first apparatus, information related to the UE performance feedback that is based on the determination.

In a ninth aspect of the present disclosure, there is provided a third apparatus. The third apparatus comprises means for performing a handover from a second apparatus to a first apparatus; and means for transmitting, to the first apparatus, at least one positioning signaling that facilitate a measurement for a user equipment, UE, performance feedback for third apparatus.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A to FIG. 1C illustrate schematic diagrams of communication environment according to some solutions, respectively;

FIG. 2 illustrates an example communication environment in which example embodiments of the present disclosure can be implemented;

FIG. 3 illustrates a schematic diagram of a functional framework;

FIG. 4 illustrates a signaling flow of UE performance feedback reporting in accordance with some embodiments of the present disclosure;

FIG. 5 illustrates a schematic diagram of a communication environment according to some example embodiments;

FIG. 6 illustrates a flowchart of a method implemented at a first device according to some example embodiments of the present disclosure;

FIG. 7 illustrates a flowchart of a method implemented at a second device according to some example embodiments of the present disclosure;

FIG. 8 illustrates a flowchart of a method implemented at a third device according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an

IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

The term “UE performance feedback” used herein may refer to information that reflects how well a UE performs communications. The term “measurement for UE performance feedback” used herein may refer to a measurement that can obtains one or more metrics of the UE performance. The term “AI/ML model” used herein may refer to a data driven algorithm that applies AI/ML techniques to generate a set of outputs based on a set of inputs. The term “AI/ML model” may be interchangeably with the term “model.”

As mentioned above, the AI/ML can be employed in load balancing and mobility optimization, which, thereby involves decisions upon UE handover from a source to a target cell (or at beam level). Taking the load balancing use case as an example, the objective of load balancing is to distribute load evenly among cells (or beams) and among areas of cells, or to transfer part of the traffic from congested cells or from congested areas of cells, or to offload users from one cell, cell area, beam, carrier or radio access technology (RAT) to another to improve network performance. This can be done by means of optimization of handover parameters and handover actions. The automation of such optimization can provide high quality user experience, while simultaneously improving the system capacity and also to minimize human intervention in the network management and optimization tasks. Further, UE load balancing is not an easy task to address with classical optimization tools, as traffic load and network resource status may change in a very dynamic fashion, therefore, it is hard to determine whether UE service performance meets the desired targets after an offloading action is taken.

To alleviate this issue and to automate such load balancing optimization that ensures user experience of high quality with only minimal human intervention to network management tasks, the usage of AI/ML-based solutions can be proven useful. For example, based on collection of various measurements and feedbacks from UEs and network nodes, historical data, etc. AI/ML model-based solutions and predicted load could improve load balancing performance, in order to provide higher quality user experience and to improve the system capacity.

According to some solutions, a framework including a UE feedback mechanism for improved Energy Efficiency (EE) configuration is proposed. In particular, a network/UE interaction involving determined UE performance feedback in the form of EE and/or Quality-of-Service (QOS) is proposed. Nonetheless, the timing configuration for such feedback information is not clarified. According to some other solutions, it proposes that the network receives from a UE connection event information, together with associated channel conditions to then determine a connection behavior status of this UE based on a classification method and take corrective action. Nonetheless, there is not detail on the timing configuration for such event-based reporting.

UE performance feedback measurement reporting is important for an NG-RAN node to evaluate inference (prediction) accuracy of its hosted ML model and, therefore, correctness of the action taken (e.g., decision upon UE handover). Such reporting can be either one-time or periodic. However, regardless of such reporting being provided to a NG-RAN node only once or in a periodic fashion, such UE performance feedback measurement reporting with a pre-fixed requested total duration period may lead to capturing UE performance feedback measurements that either are insufficient to evaluate an ML-based action taken by an NG-RAN node, as only achieving a limited precision of the monitored UE quality of service (QOS) metrics or they are (partly) out of the context of the event occurred as a result of an ML-based action taken by an NG-RAN node. In the following, focusing on the UE handover example, it shows how UE performance feedback measurement reporting with static (and, therefore, context unaware) timing configuration can lead to false interpretation of the evaluated AI/ML-based decision by the action-taking NG-RAN node.

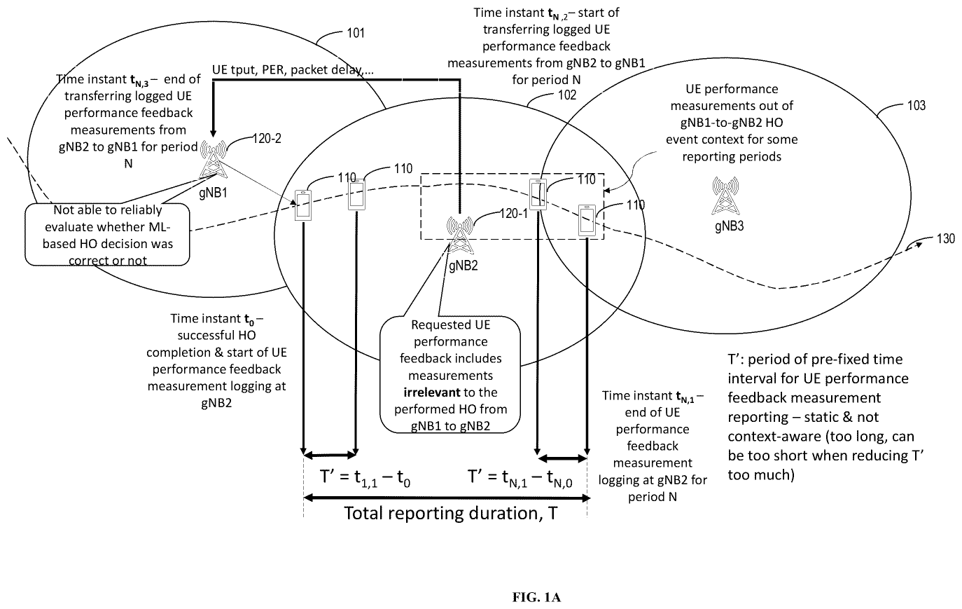

In some solutions, providing the UE performance feedback periodically may reflect the UE conditions experienced at different positions of the target cell even close to the border of other cell depending on UE velocity and target cell size. Considering the UE performance feedback, this may, therefore, be out of context and lead to some false interpretation of improper selection of the target cell for handover. FIG. 1A illustrates an example of UE handover from a source cell to a target cell, where, periodic UE performance feedback measurement reporting, as requested by the source NG-RAN node with a pre-fixed period duration may lead to the dispatch of UE performance feedback measurements that are out of context of evaluating the specific UE handover event. For example, as shown in FIG. 1A, gNB 1 may provide a cell 101, gNB2 may provide a cell 101 and gNB3 may provide a cell 103. The UE 110 may move along a trajectory 130. In this case, the UE 110 may be handed over from the gNB 1 to gNB2 and then handed over from gNB2 to gNB3. In this situation, it is possible that the gNB2 continuous reports the UE performance feedback to the gNB1 even after the UE 110 is handed over to gNB3, which may lead to a false perception of the accuracy of the ML-based UE handover action taken.

In some other solutions, one time UE performance feedback measurement reporting is concerned, and with respect to the reporting time configuration (i.e., the pre-fixed maximum duration of UE performance feedback measurement reporting), similar arguments can be thought of regarding the relevance of (part of) these recorded UE QoS measurements to the context of the event (e.g., UE handover with a certain quality) occurring as a result of an ML-based (or ML-assisted) action at an NG-RAN node. On one hand, always focusing on the load balancing use case as an example, if the recorded UE QOS measurements cover a very short time span, it will not be clear to the source gNB whether the UE handover event was successful, as the precision requested for the UE QoS metrics of focus can only be achieved with excessive internal sampling rate for the target gNB, as shown in FIG. 1B. On the other hand, if the recorded UE performance feedback measurements cover a very long time span, there is a risk for the source gNB to also obtain out of context UE QOS measurements, i.e., reflecting another possible UE handover event from the target cell to a third cell, an event which is generally unrelated to the one of focus, as shown in FIG. IC.

Therefore, given the above described limitations of static, pre-fixed time configuration for UE performance feedback measurement reporting, the problem to solve can be phrased as follows: how to design a timing configuration for the building of UE performance feedback measurement reporting to be provided by a target NG-RAN node to a source (“Actor”) NG-RAN node aiming at evaluating an AI/ML-based action taken that impacts this specific UE, based on the following principles: most (ideally all) captured UE performance feedback measurements are within the context of the event occurring as a result of the ML-based action taken and the precision level of the monitored UE QOS metrics is no lower than the requested one, depending on the UE service to be supported.

According to embodiments of the present disclosure, a solution on reporting UE performance feedback is proposed. In particular, it proposes an online, adaptive, context-aware (and, therefore, relevant to an event experienced by a UE, e.g., UE handover) time configuration framework for UE performance feedback measurement reporting, useful for an NG-RAN node (or “Actor” gNB) to evaluate an ML-based action that has led to this event. In this way, it can provide accurate and proper UE performance feedback, thereby improving performances of the system.

FIG. 1 illustrates an example communication environment 100 in which example embodiments of the present disclosure can be implemented. In the communication environment 100, there may be a device 210, devices 220-1, 220-2 and 220-3. The device 220-1 can provide a cell 201, the device 220-2 can provide a cell 202, and the device 220-3 can provide a cell 203. The devices 210, 220-2, 220-2 and 220-3 can communicate with each other.

In the following, for the purpose of illustration, some example embodiments are described with the device 210 operating as a terminal device and the devices 220-1, 220-2 and 220-3 operating as network devices. However, in some example embodiments, operations described in connection with a terminal device may be implemented at a network device or other device, and operations described in connection with a network device may be implemented at a terminal device or other device. Only for the purpose of illustrations, the device 220-1 may be described as a target network device and the device 220-2 may be described as a source network device hereinafter.

In some example embodiments, if the device 210 is a terminal device and the device 220-1 is a network device, a link from the device 220-1 to the device 210 is referred to as a downlink (DL), and a link from the device 210 to the device 220-1220-1 is referred to as an uplink (UL). In DL, the device 220-1 is a transmitting (TX) device (or a transmitter) and the device 210 is a receiving (RX) device (or a receiver). In UL, the device 210 is a TX device (or a transmitter) and the device 220-1 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

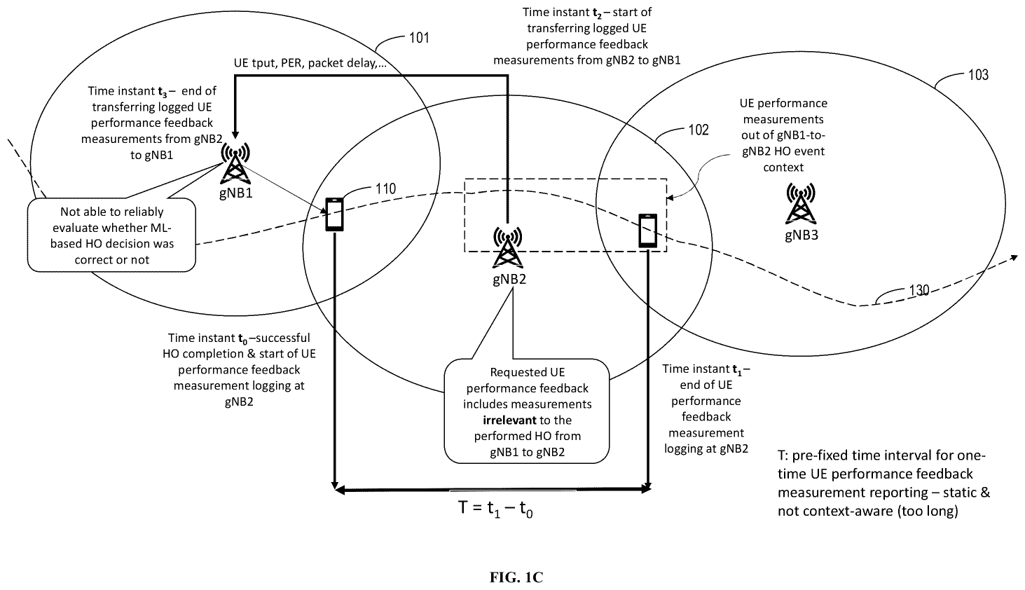

A functional frame for RAN intelligence can be applied in the communication environment 100. FIG. 3 shows a schematic diagram of an AL/ML framework 300. As shown in FIG. 3, the AI/ML framework 300 may include a data collection module 310, a model training module 320, a model inference model 330, and an actor 340. The data collection module 310 may implement a function that provides input data to Model training and Model inference modules. AI/ML algorithm specific data preparation (e.g., data pre-processing and cleaning, formatting, and transformation) is not carried out in the data collection module 310. Examples of input data may include measurements from UE or different network entities, feedback from Actor, output from an AI/ML model. The training data may refer to data needed as input for the AI/ML Model training module 320. The inference data may refer to data input for the AI/ML Model inference module 330.

The model training module 320 may implement a function that performs the AI/ML model training, validation, and testing which may generate model performance metrics as part of the model testing procedure. The Model Training module is also responsible for data preparation (e.g., data pre-processing and cleaning, formatting, and transformation) based on Training Data delivered by a Data Collection function, if required. Model Deployment/Update may be used to initially deploy a trained, validated, and tested AI/ML model to the model inference module 130 or to deliver an updated model to the model inference module 130.

The model inference module 330 may implement a function that provides AI/ML model inference output (e.g., predictions or decisions). The model inference model 330 may provide a model performance feedback to the model training module 320 when applicable. The model inference module 330 is also responsible for data preparation (e.g., data pre-processing and cleaning, formatting, and transformation) based on inference data delivered by the data collection module 310, if required. An output of the model inference module 330 may refer to an inference output of the AI/ML model produced by a Model Inference function. The model performance feedback may be used for monitoring the performance of the AI/ML model, when available.

The actor 340 may implement a function that receives the output from the model inference module 330 and triggers or performs corresponding actions. The actor 340 may trigger actions directed to other entities or to itself. In some example embodiments, the device 220-2 may act as the actor 340. The feedback information flow from the actor 320 to the data collection module 310 may be defined as follows: “Feedback: Information that may be needed to derive training data, inference data or to monitor the performance of the AI/ML Model and its impact to the network through updating of KPIs and performance counters”.

Example embodiments of the present disclosure will be described in detail below with reference to the accompanying drawings.

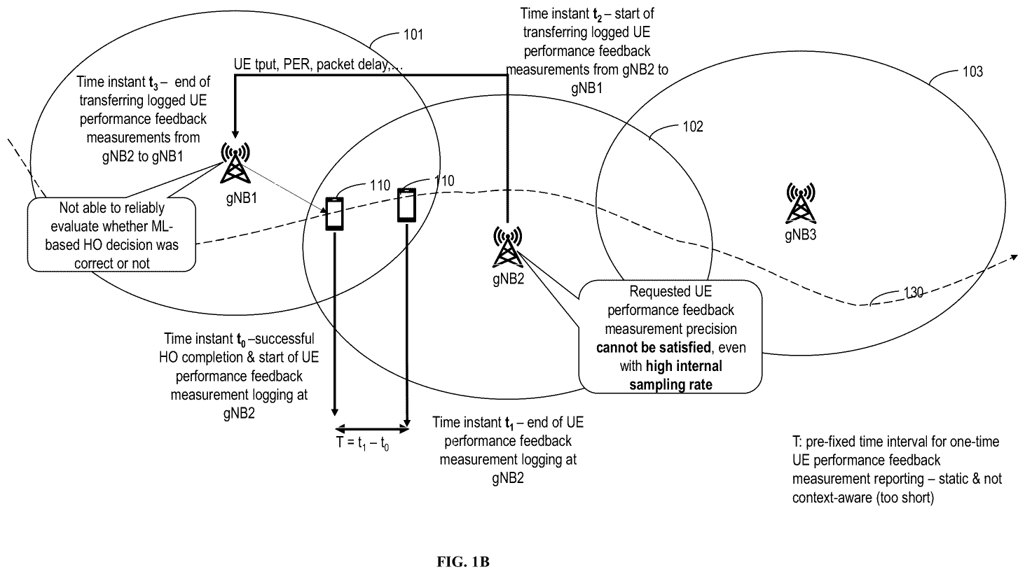

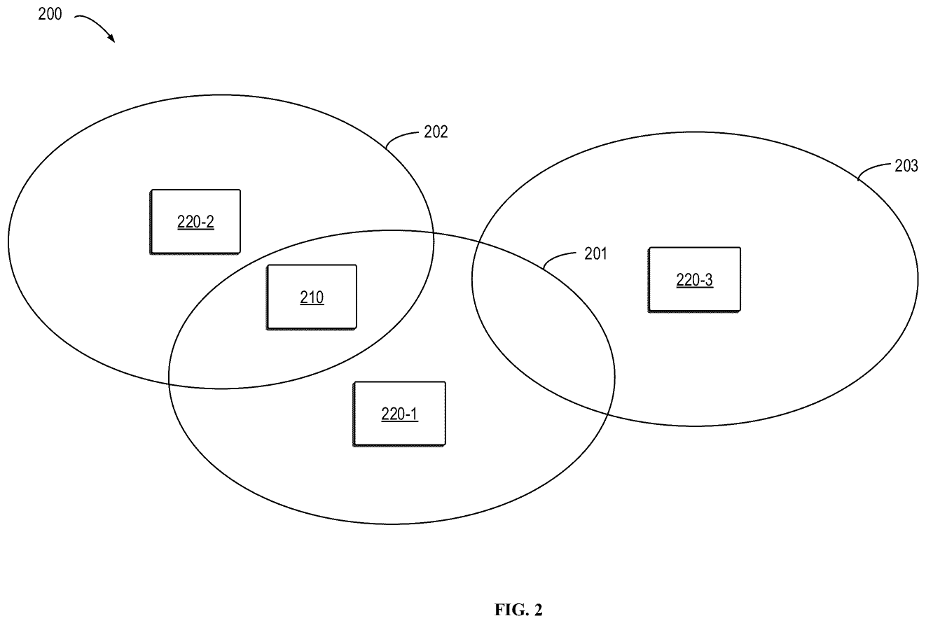

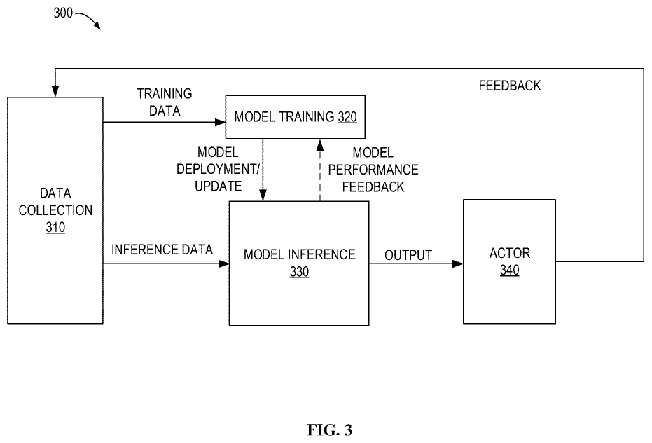

Reference is made to FIG. 4, which illustrates a signaling flow 400 in accordance with some embodiments of the present disclosure. For the purposes of discussion, the signaling flow 400 will be discussed with reference to FIG. 2 and FIG. 5, for example, by using the device 210, the device 220-1, and the device 220-2.

The device 220-2 transmits (4010) a request for UE performance feedback for the device 210 to the device 220-1. In other words, the device 220-1 receives the request for UE performance feedback for the device 210 from the device 220-2. The request indicates a set of measurement requirements. For example, the set of measurement requirements may be as part of the message body of the request issued by an Actor (i.e., the device 220-2). The request may be issued to evaluate the effect of a ML-based (or ML-assisted) action on a specific UE (for example, the device 210) that is affected by this action (e.g., UE handover to a target cell). The set of measurement requirements accompanying the request for UE performance feedback measurement can define the dynamic timing configuration for the duration of the collection of UE performance feedback measurements in a way jointly.

In some example embodiments, the set of measurement requirements may indicate a maximum reporting time for the UE performance feedback. For example, the request may include an information element (IE) {MaxReportingTime} that represents the maximum allowable time interval for the purpose of UE performance feedback measurement reporting.

Alternatively, or in addition, the set of measurement requirements may indicate a precision level of metric for the UE performance feedback. For example, the request may include an IE {KpiPrecision} that represents the required precision of each of the requested UE QoS metrics (for example, DL/UL data rate, packet loss rate, packet delay). For example, the monitored UE QoS metrics may be statistically significant and, therefore, sufficiently representative of the service experience at the UE and any changes to it. By way of example, the precision level of metric for the UE performance feedback may include at least one of: a precision level of measured UE data rate, a precision level of measured packet loss rate, or a precision level of measure packet delay. In particular, the precision level of measured UE data rate (UL/DL) may refer to a maximum tolerable deviation of X kbps from the true (average) UE data rate that is in the order of Mbps. Value X can be small for enhanced mobile broadband (eMBB) services (as a critical QoS metric) running at the UE and more relaxed for Ultra-Reliable and Low Latency Communications (URLLC) services. In case the true value cannot be calculated, a minimum required number of UE data rate measurements that need to be performed. Further, the precision level of measured packet loss rate may refer to a maximum tolerable deviation of Y or more orders of magnitude from the true (average) UE packet loss rate. Value Y can be small for critical communications and larger for not critical (near real-time) services. In case the true value cannot be calculated, a minimum required number of uploaded UE packets that need to be classified as correctly/incorrectly received. Moreover, the precision level of measured packet delay may refer to a maximum tolerable deviation of Z or more milliseconds from the true (average) UE packet delay. Value Z can be small for critical communications and larger for not critical (near real-time) services. In case the true value cannot be calculated, a minimum required number of transmitted UE packets for each of which packet reception delay needs to be measured.

In some other example embodiments, the set of measurement requirements may indicate a distance between the device 220-2 and the device 210. For example, the request may include an IE “SCellDist” that represents the distance between the UE and the source gNB (i.e., the device 220-2). This IE can be expressed, for example, as percentage of cell radius (for example, M % shown in FIG. 5). Regarding the UE distance monitoring, a simple approach may be based on Timing Advance (TA) technique which allows to determine UE distance from the source gNB and subsequently determine the ratio of this distance to cell radius (for example, the radius R240 shown in FIG. 5) which is a configured parameter SCellDist. Another approach for this distance determination may be based on Global Positioning System (GPS) from UE application layer. For example, the collected UE performance feedback measurements may be tightly relevant to the context of the ML-based or ML-assisted action taken by the device 220-2 (e.g., decision upon UE handover to a target cell) and do not represent UE QoS changes due to another event not related to the one of focus (e.g., UE Handover from-initially considered-target cell to another (third) cell). In this case, an example of this context-ensuring requirement may be a space-time situation of a focused UE (i.e., the device 210) when its performance feedback measurements are collected by the device 220-1 (i.e., the target gNB), i.e., whether (i) its distance from the device 220-2 (i.e., the source gNB) is such that the experienced UE service is a by-product of the ML-based action taken and (ii) the UE QOS metrics are monitored during a time interval starting from the completion of the action taken. Another example of this context-ensuring requirement may be an occurrence of another event (e.g., a HO event triggered), not related to the one which is the result of an action taken by the device 220-2. In some other example embodiments, the set of measurement requirements may indicate available resources for the UE performance feedback.

The device 220-1 may transmit (4020) an acknowledgement (ACK) for the request to the device 220-2. In other words, the device 220-2 may receive the ACK for the request from the device 220-1. By way of example, the device 220-1 may transmit a response indicating the ACK of the request to the device 220-2.

During a handover procedure, the device 210 can be handed over from the device 220-2 (i.e., the source network device) to the device 220-2 (i.e., the target device 220-1). For example, as shown in FIG. 5, along the trajectory 230, the device 210 may move from the cell 202 to the cell 201, i.e., handover from the device 220-2 to the device 220-1. It is noted that the handover procedure can be performed according to any proper approaches. As shown in FIG. 5, the successful HO completion may be at time instance t₂₅₀.

The device 210 transmits (4030) at least one positioning signaling to the device 220-1. In other words, the device 220-1 receives the at least one positioning signaling from the device 210. The at least one positioning signaling facilitates the measurement for the UE performance feedback for the device 210. For example, the positioning signaling may indicate GPS of the device 210. Alternatively, the positing signaling may related to TA signaling.

The device 220-1 performs (4040) a measurement for UE performance feedback. For example, the device 220-1 may measure UE data rate (such as, UL data and/or DL data). Alternatively, or in addition, the device 220-1 may measure a packet loss rate for the device 210. In some other example embodiments, the device 220-1 may measure a packet delay for the device 210. The device 220-2 may also measure a distance between the device 210 and the device 220-1. For example, the device 220-2 may measure the distance based on the received (4030) positioning signaling. In some example embodiments, the device 220-1 may measure a packet error rate (PER) for the device 210. As shown in FIG. 5, the device 220-1 may start collecting the UE performance feedback at time instance t₂₅₀.

The device 220-1 may determine (4050) whether a termination condition for the measurement is satisfied. In other words, the device 220-1 may determine a maximum allowable time interval (for example, T205 in FIG. 5) for the purpose of UE performance feedback measurement reporting based on whether the termination condition is satisfied. For example, as shown in FIG. 5, the device 220-1 may stop the measurement the UE performance feedback at the time instant t₂₅₁.

In some example embodiments, the termination condition may include an expiration of a timer set by the device 220-2. For example, the termination condition may include Measurement termination Rule 1 where UE performance feedback measurement collection terminates when a maximum timer set by the device 220-2 (i.e., source gNB) expires. In this situation, for reporting success/failure evaluation, in case the distance of the device 210 from the device 220-2 (i.e., its source gNB) is below a threshold and the required precision level is achieved for all UE QOS metrics at time of measurement termination then UE performance feedback measurement reporting is successful, otherwise it is unsuccessful.

Alternatively, or in addition, the termination condition may include a trigger of another handover event for the device 210 during the measurement for the UE performance feedback. For example, the termination condition may include Measurement termination Rule 2 where UE performance feedback measurement collection terminates when, another handover event is triggered for the device 210 during performance feedback measurement collection. In this situation, for reporting success/failure evaluation, in case the distance of the device 210 from the device 220-2 (i.e, its source gNB) is below a threshold and the required precision level is achieved for all UE QoS metrics at time of measurement termination then UE performance feedback measurement reporting is successful, otherwise it is unsuccessful. Alternatively, or in addition, the termination condition may include a termination rule that UE performance feedback measurement collection is terminated when the device 210 connects to a different beam to the one it connected during the handover.

Alternatively, or in addition, in some example embodiments the termination condition may include a trigger that the radio conditions reported by the device 210 to the target gNB, e.g., in terms of one or more of: reference signal received power (RSRP) measurement, or reference signal received quality (RSRQ) measurement, drop below a first threshold value. Alternatively, or in addition, in some example embodiments the termination condition may include a trigger that the radio conditions reported by the device 210 to the target gNB, e.g., in terms of RSRP, RSRQ, or signal to interference and noise ratio (SINR) measurement become higher than a second threshold value.

Alternatively, or in addition, in some example embodiments the termination condition may include a trigger that the dual connectivity is enabled at the device 210.

In some example embodiments, the termination condition may include a distance between the device 210 and the device 220-2 exceeding a threshold distance. For example, the termination condition may include Measurement termination Rule 3 where UE performance feedback measurement collection terminates when the distance of the device 210 from the device 220-2 (i.e., its source gNB) is over a threshold. In this situation, for reporting success/failure evaluation, in case the required precision level is achieved for all UE QOS metrics at time of measurement termination then UE performance feedback measurement reporting is successful, otherwise it is unsuccessful.

Alternatively, or in addition, the termination condition may include a precision level of the measurement being equal to or above a precision level indicated in the set of measurement requirements. For example, the termination condition may include Measurement termination Rule 4 where UE performance feedback measurement collection terminates when sufficient performance measurements are gathered, resulting in precision level(s) equal to or above the one(s) requested for all UE QoS metrics. In this situation, for reporting success/failure evaluation, in case the distance of the device 210 from the device 220-2 (i.e., its source gNB) is below a threshold and at time of measurement termination then UE performance feedback measurement reporting is successful, otherwise it is unsuccessful.

In some example embodiments, the termination condition may include available resources at the device 220-1 being below a threshold value. For example, the termination condition may include Measurement termination Rule 5 where UE performance feedback measurement collection terminates when the available computing resources at the device 220-1 (i.e., target gNB) dedicated for such performance measurement collection is below a threshold value. In this situation, for reporting success/failure evaluation, in case the distance of the device 210 from the device 220-2 (i.e., its source gNB) is below a threshold and the required precision level is achieved for all UE QOS metrics at time of measurement termination then UE performance feedback measurement reporting is successful, otherwise it is unsuccessful.

Alternatively, or in addition, the termination condition may include any one or combination of the above mentioned conditions. For example, the termination condition may include Measurement termination Rule 6 where UE performance feedback measurement collection terminates whichever condition (for Measurement termination Rule 1 or for Measurement termination Rule 2 or for Measurement termination Rule 3 or for Measurement termination Rule 4 or for Measurement termination Rule 5) is triggered first.

If the termination condition is satisfied, the device 220-1 determines (4060) whether the set of measurement requirements is satisfied. The device 220-1 transmits (4070), to the device 220-2, information related to UE performance feedback that is based on the determination (4060). In other words, the device 220-2 receives the information related to UE performance feedback from the device 220-1. As shown in FIG. 5, the device 220-1 may start to transmit the information related to UE performance feedback at the time instant t₂₅₂. The device 220-1 may stop the transmission of the information related to UE performance feedback at the time instant t₂₅₃. In this way, it can achieve context-aware time configuration for the UE performance feedback.

In an example embodiment, if the set of measurement requirements is satisfied, the device 220-1 may transmit (4070), to the device 220-2, the information indicating a result of the measurement for the UE performance feedback. For example, the device 220-1 may transmit a one-time success response (i.e., an AI/ML information updated message via the Xn interface) carrying the UE performance feedback measurement report in its message body, in the case of successful (i.e., context-aware and timely) reporting. By way of example, the information may include an IE “KpiValue” that represents the values of the requested UE QOS KPIs (e.g., DL/UL data rate, packet loss rate, packet delay) when averaged during the time interval for UE performance feedback monitoring in the case of successful UE performance feedback measurement reporting operation.

Alternatively, if the set of measurement requirements is unsatisfied, the device 220-1 may transmit (4070), to the device 220-2, the information indicating a cause of a failure in the measurement for the UE performance feedback. For example, the device 220-1 may transmit a one-time non-success response (i.e., an AI/ML information failure via the Xn interface) carrying a cause value explaining the reason for reporting failure in its message body. By way of example, the information may include an IE “CauseValue” represents the value of the cause that has led to an unsuccessful UE performance feedback measurement reporting operation.

In an example embodiment, the cause of the failure may include an insufficient measurement precision withing running time of the timer. For example, the IE may be “INSUFFICIENT MEASUREMENT PRECISION—MAX TIMER EXPIRED” in case: {KpiPrecision} cannot be satisfied for all requested UE QOS KPIs within a pre-defined time interval (ending by timer expiration), while the SCellDist threshold is not overcome at the same time.

In another example embodiment, the cause of the failure may include an insufficient measurement precision after a context limit of the UE performance feedback is reached. For example, the IE may be “INSUFFICIENT MEASUREMENT PRECISION—CONTEXT LIMIT REACHED” in case {KpiPrecision} cannot be satisfied for all requested UE QoS KPIs, given that UE performance feedback measurement recording has terminated due to the SCellDist criterion being met.

In a further example embodiment, the cause of the failure may include partial out of context measurements. For example, the IE may be “PARTIAL OUT-OF-CONTEXT MEASUREMENTS” in case {KpiPrecision} is satisfied, however, i) SCellDist has been violated prior to measurement termination (e.g., the target gNB has obtained this distance information with some delay) or ii) another event (e.g., UE HO to another cell) has been triggered in the meantime.

Alternatively, or in addition, the cause of the failure may include insufficient computing resources for the measurement for the UE performance feedback. For example, the IE may be “INSUFFICIENT COMPUTING RESOURCES” in case UE performance feedback measurement reporting is interrupted (and either requirement {KpiPrecision} or SCellDist is unsatisfied) or the source gNB request is rejected directly after the target gNB receives it, due to the lack of computing (CPU, memory, storage) resources that are needed to gather and process the collected UE performance feedback measurements). For example, with the only exception of the case where the device 220-1 has insufficient computation resources at the time of initially receiving the AI/ML INFORMATION REQUEST configuration message (and, thus, instead of an AI/ML INFORMATION RESPONSE acknowledgment message, an AI/ML INFORMATION FAILURE message can be sent back with Cause Value=“INSUFFICIENT COMPUTING RESOURCES”). In all other cases, the device 220-1 may always initiate the UE performance feedback measurement reporting. In these cases, operation success or failure may only be evaluated by the device 220-1 after one of the proposed measurement termination Rules 1-6 for measurement reporting termination is activated.

In some example embodiments, the MaxReportingTime requirement (in the above measurement termination Rule 1) may provide the maximum waiting time for the device 220-2 to receive the information related to the UE performance feedback after the time instant where an event of focus (e.g., UE HO execution completion) occurs.

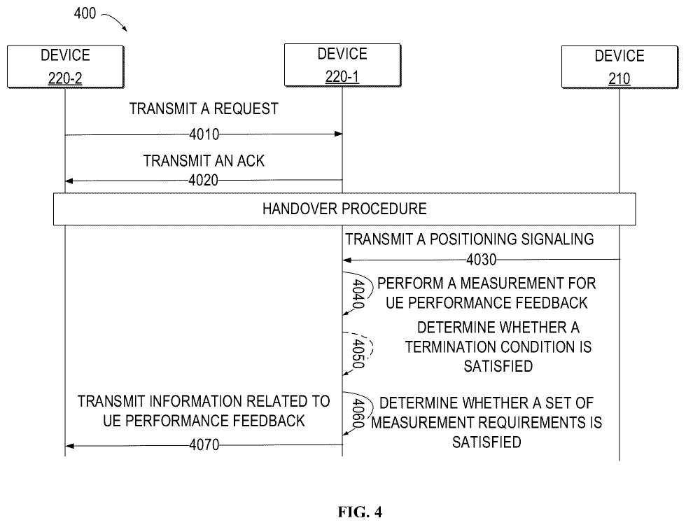

FIG. 6 shows a flowchart of an example method 600 implemented at a first apparatus in accordance with some example embodiments of the present disclosure. For example, the method 600 may be implemented at the device 210 in FIG. 2.

At block 610, the first apparatus receives, from a second apparatus, a request for user equipment, UE, performance feedback for a third apparatus. The request indicates a set of measurement requirements. The third apparatus is handed over from the second apparatus to the first apparatus.

At block 620, the first apparatus performs a measurement for the UE performance feedback for the third apparatus.

At block 630, in accordance with a determination that a termination condition for the measurement is satisfied, the first apparatus determines whether the set of measurement requirements is satisfied based on the measurement for the UE performance feedback.

At block 640, the first apparatus transmits, to the second apparatus, information related to the UE performance feedback that is based on the determination.

In some example embodiments, the set of measurement requirements indicates at least one of: a precision level of metric for the UE performance feedback, a maximum reporting time for the UE performance feedback, a distance between the third apparatus and the second apparatus, or available resources for the UE performance feedback.

In some example embodiments, the precision level of metric for the UE performance feedback comprises at least one of: a precision level of measured UE data rate, a precision level of measured packet loss rate, or a precision level of measure packet delay.

In some example embodiments, the termination condition for the measurement comprises at least one of: an expiration of a timer set by the second apparatus, a trigger of another handover event for the third apparatus during the measurement for the UE performance feedback, a distance between the third apparatus and the second apparatus exceeding a threshold distance, a precision level of the measurement being equal to or above a precision level indicated in the set of measurement requirements, available resources at the first apparatus being below a threshold value, the third apparatus connecting to a beam which is different from that used in during handover, a radio condition reported by the third apparatus dropping below a first threshold value, the radio condition reported by the third apparatus becoming higher than a second threshold value, or a dual connectivity being enabled at the third apparatus.

In some example embodiments, the method 600 further comprises: in accordance with a determination that the set of measurement requirements is satisfied, transmitting, to the second apparatus, the information indicating a result of the measurement for the UE performance feedback.

In some example embodiments, the method 600 further comprises: in accordance with a determination that the set of measurement requirements is unsatisfied, transmitting, to the second apparatus, the information indicating a cause of a failure in the measurement for the UE performance feedback.

In some example embodiments, the cause of the failure comprises at least one of: an insufficient measurement precision withing running time of the timer, an insufficient measurement precision after a context limit of the UE performance feedback is reached, partial out of context measurements, or insufficient computing resources for the measurement for the UE performance feedback.

In some example embodiments, the first apparatus is a target network device, the second apparatus is a source network device, and the third apparatus is a terminal device.

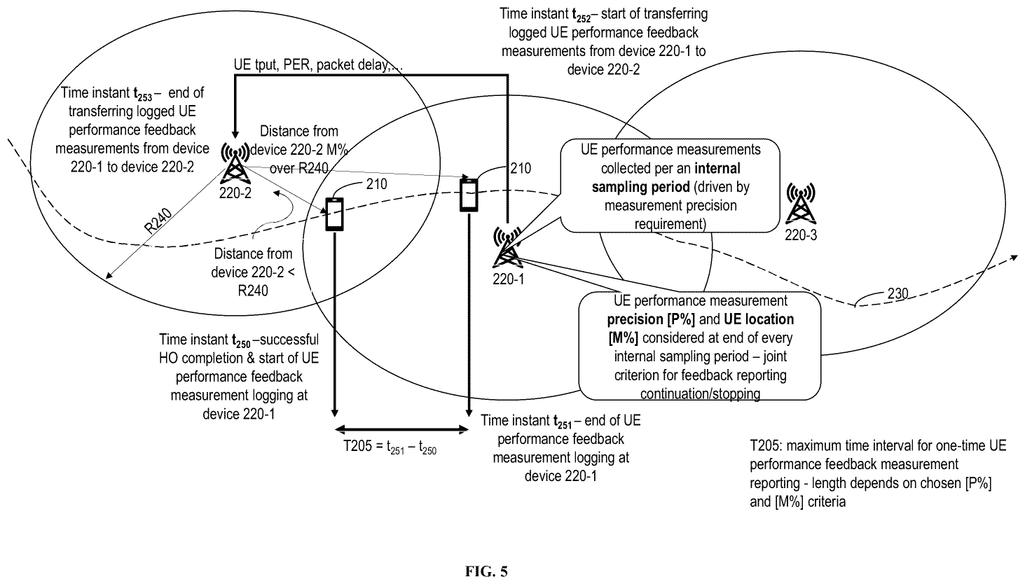

FIG. 7 shows a flowchart of an example method 700 implemented at a second apparatus in accordance with some example embodiments of the present disclosure. For example, the method 700 can be implemented at the device 220-1 in FIG. 2.

At block 710, the second apparatus transmits, to a first apparatus, a request for user equipment, UE, performance feedback for a third apparatus. The request indicates a set of measurement requirements. The third apparatus is handed over from the second apparatus to the first apparatus.

At block 720, the second apparatus receives, from the first apparatus, information related to the UE performance feedback that is based on the determination.

In some example embodiments, the set of measurement requirements indicates at least one of: a precision level of metric for the UE performance feedback, a maximum reporting time for the UE performance feedback, or a distance between the third apparatus and the second apparatus.

In some example embodiments, the precision level of metric for the UE performance feedback comprises at least one of: a precision level of measured UE data rate, a precision level of measured packet loss rate, or a precision level of measure packet delay.

In some example embodiments, the method 700 further comprises: receiving, from the first apparatus, the information indicating a result of the measurement for the UE performance feedback.

In some example embodiments, the method 700 further comprises: receiving, from the first apparatus, the information indicating a cause of a failure in the measurement for the UE performance feedback.

In some example embodiments, the cause of the failure comprises at least one of: an insufficient measurement precision withing running time of the timer, an insufficient measurement precision after a context limit of the UE performance feedback is reached, partial out of context measurements, or insufficient computing resources for the measurement for the UE performance feedback.

In some example embodiments, the first apparatus is a target network device, the second apparatus is a source network device, and the third apparatus is a terminal device.

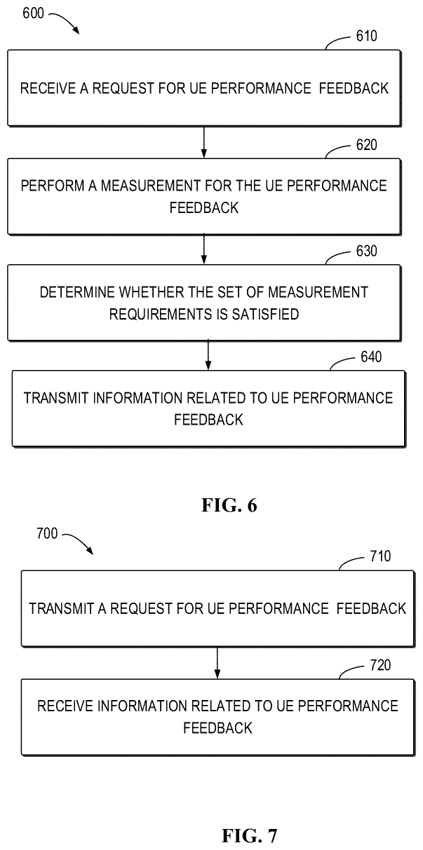

FIG. 8 shows a flowchart of an example method 800 implemented at a third apparatus in accordance with some example embodiments of the present disclosure. For the purpose of discussion, the method 800 may be implemented at the device 220-2 in FIG. 2.

At block 810, the third apparatus performs a handover from a second apparatus to a first apparatus.

At block 820, the third apparatus transmits, to the first apparatus, at least one positioning signaling that facilitate a measurement for a user equipment, UE, performance feedback for third apparatus.

In some example embodiments, the first apparatus is a target network device, the second apparatus is a source network device, and the third apparatus is a terminal device.

In some example embodiments, a first apparatus capable of performing any of the method 600 (for example, the device 210 in FIG. 2) may comprise means for performing the respective operations of the method 600. The means may be implemented in any suitable form. For example, the means may be implemented in a circuitry or software module. The first apparatus may be implemented as or included in the device 210 in FIG. 1.

In some example embodiments, the first apparatus comprises means for receiving, from a second apparatus, a request for user equipment, UE, performance feedback for a third apparatus, wherein the request indicates a set of measurement requirements, and wherein the third apparatus is handed over from the second apparatus to the first apparatus; means for performing a measurement for the UE performance feedback for the third apparatus,; means for in accordance with a determination that a termination condition for the measurement is satisfied, determining whether the set of measurement requirements is satisfied based on the measurement for the UE performance feedback; and means for transmitting, to the second apparatus, information related to the UE performance feedback that is based on the determination.

In some example embodiments, the set of measurement requirements indicates at least one of: a precision level of metric for the UE performance feedback, a maximum reporting time for the UE performance feedback, a distance between the third apparatus and the second apparatus, or available resources for the UE performance feedback.

In some example embodiments, the precision level of metric for the UE performance feedback comprises at least one of: a precision level of measured UE data rate, a precision level of measured packet loss rate, or a precision level of measure packet delay.

In some example embodiments, the termination condition for the measurement comprises at least one of: an expiration of a timer set by the second apparatus, a trigger of another handover event for the third apparatus during the measurement for the UE performance feedback, a distance between the third apparatus and the second apparatus exceeding a threshold distance, a precision level of the measurement being equal to or above a precision level indicated in the set of measurement requirements, available resources at the first apparatus being below a threshold value, the third apparatus connecting to a beam which is different from that used in during handover, a radio condition reported by the third apparatus dropping below a first threshold value, the radio condition reported by the third apparatus becoming higher than a second threshold value, or a dual connectivity being enabled at the third apparatus.

In some example embodiments, the first apparatus further comprises: means for in accordance with a determination that the set of measurement requirements is satisfied, transmitting, to the second apparatus, the information indicating a result of the measurement for the UE performance feedback.

In some example embodiments, the first apparatus further comprises: means for in accordance with a determination that the set of measurement requirements is unsatisfied, transmitting, to the second apparatus, the information indicating a cause of a failure in the measurement for the UE performance feedback.

In some example embodiments, the cause of the failure comprises at least one of: an insufficient measurement precision withing running time of the timer, an insufficient measurement precision after a context limit of the UE performance feedback is reached, partial out of context measurements, or insufficient computing resources for the measurement for the UE performance feedback.

In some example embodiments, the first apparatus is a target network device, the second apparatus is a source network device, and the third apparatus is a terminal device.

In some example embodiments, the first apparatus further comprises means for performing other operations in some example embodiments of the method 600 or the device 210. In some example embodiments, the means comprises at least one processor; and at least one memory storing instructions that, when executed by the at least one processor, cause the performance of the first apparatus.

In some example embodiments, a second apparatus capable of performing any of the method 700 (for example, the device 220-1 in FIG. 2) may comprise means for performing the respective operations of the method 700. The means may be implemented in any suitable form. For example, the means may be implemented in a circuitry or software module. The second apparatus may be implemented as or included in the device 220-1 in FIG. 2.

In some example embodiments, the second apparatus comprises means for transmitting, to a first apparatus, a request for user equipment, UE, performance feedback for a third apparatus, wherein the request indicates a set of measurement requirements, and wherein the third apparatus is handed over from the second apparatus to the first apparatus; and means for receiving, from the first apparatus, information related to the UE performance feedback that is based on the determination.

In some example embodiments, the set of measurement requirements indicates at least one of: a precision level of metric for the UE performance feedback, a maximum reporting time for the UE performance feedback, a distance between the third apparatus and the second apparatus, or available resources for the UE performance feedback.

In some example embodiments, the precision level of metric for the UE performance feedback comprises at least one of: a precision level of measured UE data rate, a precision level of measured packet loss rate, or a precision level of measure packet delay.

In some example embodiments, the second apparatus further comprises: means for receiving, from the first apparatus, the information indicating a result of the measurement for the UE performance feedback.

In some example embodiments, the second apparatus further comprises: means for receiving, from the first apparatus, the information indicating a cause of a failure in the measurement for the UE performance feedback.

In some example embodiments, the cause of the failure comprises at least one of: an insufficient measurement precision withing running time of the timer, an insufficient measurement precision after a context limit of the UE performance feedback is reached, partial out of context measurements, or insufficient computing resources for the measurement for the UE performance feedback.

In some example embodiments, the first apparatus is a target network device, the second apparatus is a source network device, and the third apparatus is a terminal device.

In some example embodiments, the second apparatus further comprises means for performing other operations in some example embodiments of the method 700 or the device 220-1. In some example embodiments, the means comprises at least one processor; and at least one memory storing instructions that, when executed by the at least one processor, cause the performance of the second apparatus.

In some example embodiments, a third apparatus capable of performing any of the method 800 (for example, the device 220-2 in FIG. 2) may comprise means for performing the respective operations of the method 800. The means may be implemented in any suitable form. For example, the means may be implemented in a circuitry or software module. The third apparatus may be implemented as or included in the device 220-2 in FIG. 2.

In some example embodiments, the third apparatus comprises means for performing a handover from a second apparatus to a first apparatus; and means for transmitting, to the first apparatus, at least one positioning signaling that facilitate a measurement for a user equipment, UE, performance feedback for third apparatus.

In some example embodiments, the first apparatus is a target network device, the second apparatus is a source network device, and the third apparatus is a terminal device.

In some example embodiments, the third apparatus further comprises means for performing other operations in some example embodiments of the method 800 or the device 220-2. In some example embodiments, the means comprises at least one processor; and at least one memory storing instructions that, when executed by the at least one processor, cause the performance of the third apparatus.

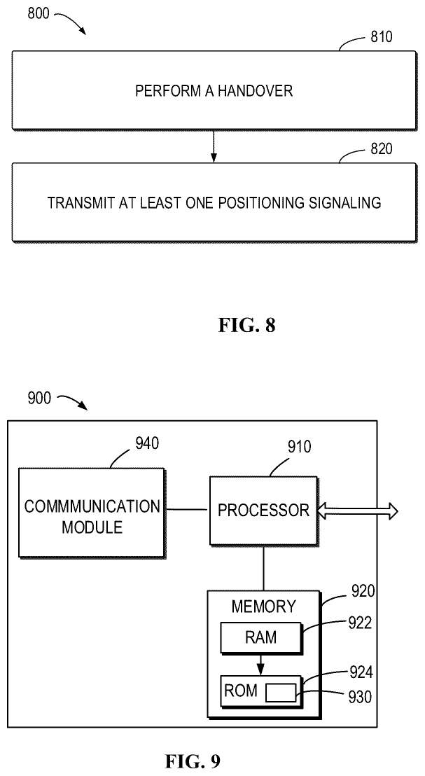

FIG. 9 is a simplified block diagram of a device 900 that is suitable for implementing example embodiments of the present disclosure. The device 900 may be provided to implement a communication device, for example, the device 210 or the device 220-1 as shown in FIG. 2. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

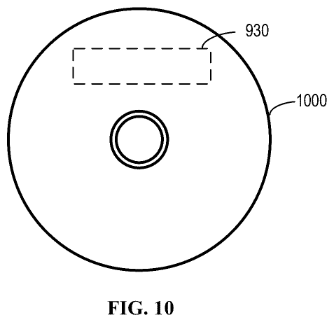

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus to:
receive, from a second apparatus, a request for user equipment, UE, performance feedback, wherein the request indicates a set of measurement requirements;
perform a measurement for the UE performance feedback for a third apparatus, wherein the third apparatus is handed over from the second apparatus to the first apparatus;
in accordance with a determination that a termination condition for the measurement is satisfied, determine whether the set of measurement requirements is satisfied based on the measurement for the UE performance feedback; and
transmit, to the second apparatus, information related to the UE performance feedback that is based on the determination.

2. The first apparatus of claim 1, wherein the set of measurement requirements indicates at least one of:
a precision level of metric for the UE performance feedback,
a maximum reporting time for the UE performance feedback,
a distance between the third apparatus and the second apparatus, or
available resources for the UE performance feedback.

3. The first apparatus of claim 2, wherein the precision level of metric for the UE performance feedback comprises at least one of:
a precision level of measured UE data rate,
a precision level of measured packet loss rate, or
a precision level of measure packet delay.

4. The first apparatus of claim 1, wherein the termination condition for the measurement comprises at least one of:
an expiration of a timer set by the second apparatus,
a trigger of another handover event for the third apparatus during the measurement for the UE performance feedback,
a distance between the third apparatus and the second apparatus exceeding a threshold distance,
a precision level of the measurement being equal to or above a precision level indicated in the set of measurement requirements,
available resources at the first apparatus being below a threshold value,
the third apparatus connecting to a beam which is different from that used in during handover,
a radio condition reported by the third apparatus dropping below a first threshold value,
the radio condition reported by the third apparatus becoming higher than a second threshold value, or
a dual connectivity being enabled at the third apparatus.

5. The first apparatus of claim 1, wherein the first apparatus is caused to:
in accordance with a determination that the set of measurement requirements is satisfied, transmit, to the second apparatus, the information indicating a result of the measurement for the UE performance feedback.

6. The first apparatus of claims 1, wherein the first apparatus is caused to:
in accordance with a determination that the set of measurement requirements is unsatisfied, transmit, to the second apparatus, the information indicating a cause of a failure in the measurement for the UE performance feedback.

7. The first apparatus of claim 6, wherein the cause of the failure comprises at least one of:
an insufficient measurement precision withing running time of the timer,
an insufficient measurement precision after a context limit of the UE performance feedback is reached,
partial out of context measurements, or
insufficient computing resources for the measurement for the UE performance feedback.

8. The first apparatus of claim 1, wherein the first apparatus is a target network device, the second apparatus is a source network device, and the third apparatus is a terminal device.

9. A second apparatus comprising:
at least one processor; and
at least one memory storing instructions that, when executed by the at least one processor, cause the second apparatus to:
transmit, to a first apparatus, a request for user equipment, UE, performance feedback for a third apparatus, wherein the request indicates a set of measurement requirements, and wherein the third apparatus is handed over from the second apparatus to the first apparatus; and
receive, from the first apparatus, information related to the UE performance feedback that is based on the determination.

10. The second apparatus of claim 9, wherein the set of measurement requirements indicates at least one of:
a precision level of metric for the UE performance feedback,
a maximum reporting time for the UE performance feedback,
a distance between the third apparatus and the second apparatus, or
available resources for the UE performance feedback.

11. The second apparatus of claim 10, wherein the precision level of metric for the UE performance feedback comprises at least one of:
a precision level of measured UE data rate,
a precision level of measured packet loss rate, or
a precision level of measure packet delay.

12. The second apparatus of claim 9, wherein the second apparatus is caused to:
receive, from the first apparatus, the information indicating a result of the measurement for the UE performance feedback.

13. The second apparatus of claim 9, wherein the second apparatus is caused to:
receive, from the first apparatus, the information indicating a cause of a failure in the measurement for the UE performance feedback.

14. The second apparatus of claim 13, wherein the cause of the failure comprises at least one of:
an insufficient measurement precision withing running time of the timer,
an insufficient measurement precision after a context limit of the UE performance feedback is reached,
partial out of context measurements, or
insufficient computing resources for the measurement for the UE performance feedback.

15. The second apparatus of claim 9, wherein the first apparatus is a target network device, the second apparatus is a source network device, and the third apparatus is a terminal device.

16. A third apparatus comprising:
at least one processor; and
at least one memory storing instructions that, when executed by the at least one processor, cause the third apparatus to:
perform a handover from a second apparatus to a first apparatus; and
transmit, to the first apparatus, at least one positioning signaling that facilitate a measurement for a user equipment, UE, performance feedback for third apparatus.

17. The third apparatus of claim 16, wherein the first apparatus is a target network device, the second apparatus is a source network device, and the third apparatus is a terminal device.
